(19) United States
(12) Patent Application Publication
(10) Pub. No.: US 2014/0160349 A1
(43) Pub. Date: Jun. 12, 2014

(54) ENGAGING STRUCTURE OF ELECTRONIC IMAGING DEVICE

(71) Applicant: CHICONY ELECTRONICS CO., LTD., New Taipei City (TW)

(72) Inventors: Wei-Cheng HUANG, New Taipei City (TW); Mei-Yi TSAI, New Taipei City (TW)

(73) Assignee: CHICONY ELECTRONICS CO., LTD., New Taipei City (TW)

(21) Appl. No.: 13/707,472

(22) Filed: Dec. 6, 2012

(51) Int. Cl. H04N 5/225

(52) U.S. Cl. CPC H04N 5/2251
USPC 348/375

(57) ABSTRACT

An accessory of an electronic imaging device is disclosed. The structure includes an electronic imaging device and a sliding seat. The electronic imaging device has a housing. A sliding slot provided in one side of the housing, and a locking element is disposed in the sliding slot. The sliding seat includes a base and a slider located in one side of the base. A junction part is disposed in another side of the base. The slider slips into the sliding slot, and the locking element fixes the slider in the sliding slot for combining the electronic imaging device with the sliding seat.

### BACKGROUND OF THE INVENTION

1. Field of the Invention

The present invention generally relates to accessories of imaging devices and, in particular to engaging structures of electronic imaging devices.

2. Description of Related Art

With the advances in technology and the popularity of the internet, an electronic imaging device such as a digital camera or a webcam is one of the essential electronic products in life. Whenever we use the camera outdoors or use the webcam at home, the electronic imaging device is often placed in a designated location for users to capture clear images. Hence, the electronic imaging devices usually have a screw hole for attaching to tripods.

However, the screw hole of the tripod is usually provided at the bottom of the electronic imaging device. Users need to look down to align the screw hole with the tripod stud. It's not easy for combining the electronic imaging devices with the tripod and departing the electronic imaging devices from the tripod, and the tripod stud might scratch the electronic imaging devices by accident. Therefore, users will have no aspirations to combine the electronic imaging devices with the tripod.

Moreover, the screw hole of the electronic imaging devices is easy to be stripped after a period time of using. Because the screw hole is provided on the electronic imaging device, it is an annoying thing for repairing. At last the electronic imaging devices will no longer be used on a tripod.

In view of the above drawbacks, the Inventor proposes the present invention based on his expert knowledge and elaborate researches in order to solve the problems of related art.

### SUMMARY OF THE INVENTION

Accordingly, an object of the present invention is to provide an engaging structure of an electronic imaging device, in which the electronic imaging device can be engaged with a tripod, and the electronic imaging device will not in a situation that a stripped screw hole is happened for repairing.

In order to achieve the object mentioned above, the present invention provides an engaging structure of an electronic imaging device. The electronic imaging device has a housing. A sliding slot provided in one side of the housing, and a locking element is disposed in the sliding slot. A sliding seat includes a base and a slider located in one side of the base, and a junction part is disposed in another side of the base. The slider slips into the sliding slot, and the locking element will fix the slider in the sliding slot for combining the electronic imaging device with the sliding seat. Therefore, the electronic imaging device can attach to a supporter.

Wherein, the locking element is a resilient piece disposed inside the housing, and an opening is disposed along a path of the sliding slot. The resilient piece has a hook corresponding to a position of the opening, and the hook is protruded outward to the sliding slot from the opening. A notch is disposed corresponding to the hook, wherein the slider slides into the sliding slot and the hook locks the slider in the notch.

Another object of the present invention is to provide an engaging structure of an electronic imaging device, in which the junction part of the sliding seat can be provided as an annulation or some other junction types for users carrying the electronic imaging device.

Comparing to the related art, the engaging structure of the present invention has the following effects. The electronic imaging device has a sliding slot and a locking element (resilient piece), and the locking element is disposed in the sliding slot. The sliding seat having a junction part and a notch slips into the sliding slot, and the locking element will fix the slider in the sliding slot so that the electronic imaging device will combine with the sliding seat. In this way, users can combine the sliding seat with a supporter (tripod) in advance, and then put the sliding seat with supporter (tripod) slipped into the sliding slot of the electronic imaging device. There will be no needs to align a supporter (tripod) with the screw hole. Besides, when the screw hole (junction part) is stripped, only the sliding seat should be replaced. A delivering of the electronic imaging device for maintenance will not be required.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective view according to the present invention;

FIG. 2 is a schematic view of the sliding seat combining with the electronic imaging device of the present invention;

FIG. 3 is a partially exploded view of the electronic imaging device of the present invention;

FIG. 4 is a partially assembling view of the electronic imaging device of the present invention;

FIG. 5 is an assembling schematic view of the engaging structure of the present invention;

FIG. 6 is a cross sectional view of the engaging structure of the present invention;

FIG. 7 is a sliding seat according to the second embodiment of the present invention;

FIG. 8 is an application view according to the second embodiment of the present invention;

FIG. 9 is a sliding seat according to the third embodiment of the present invention; and

FIG. 10 is an application view according to the third embodiment of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

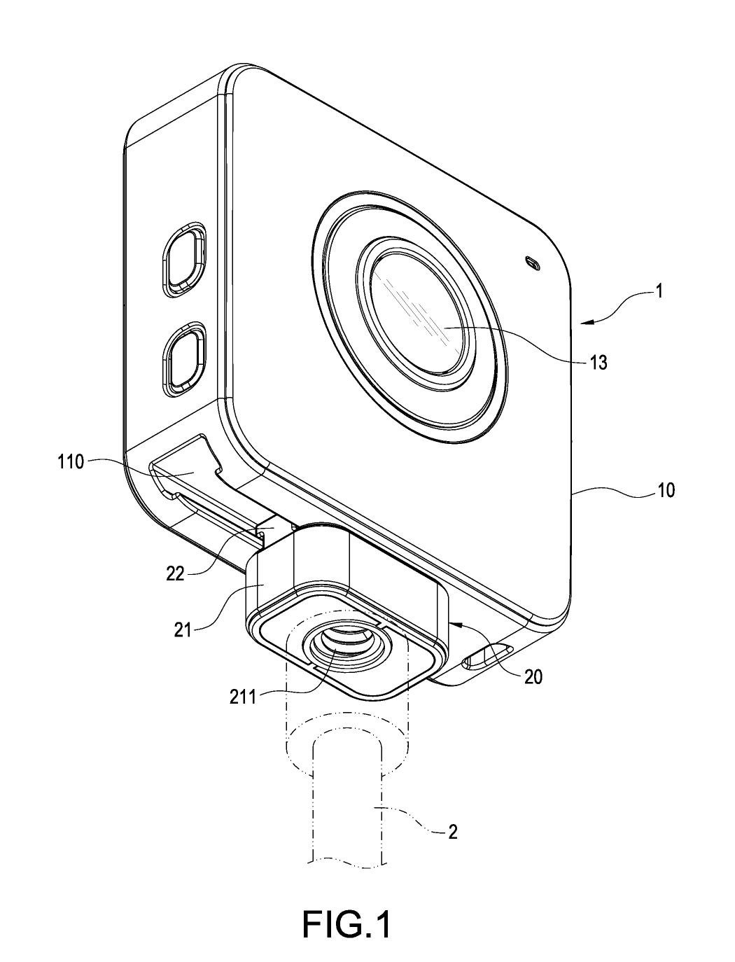

Please refer to FIG. 1, it depicts a perspective view of engaging structures of an electronic imaging device of the present invention. An engaging structure 1 of the present invention includes an electronic imaging device 10 and a sliding seat 20. The sliding seat 20 is used for connecting with a supporter 2. The sliding seat 20 connecting to the supporter 2 is slidable and can be fixed in the electronic imaging device 10, whereby, the electronic imaging device 10 will combine with the supporter 2.

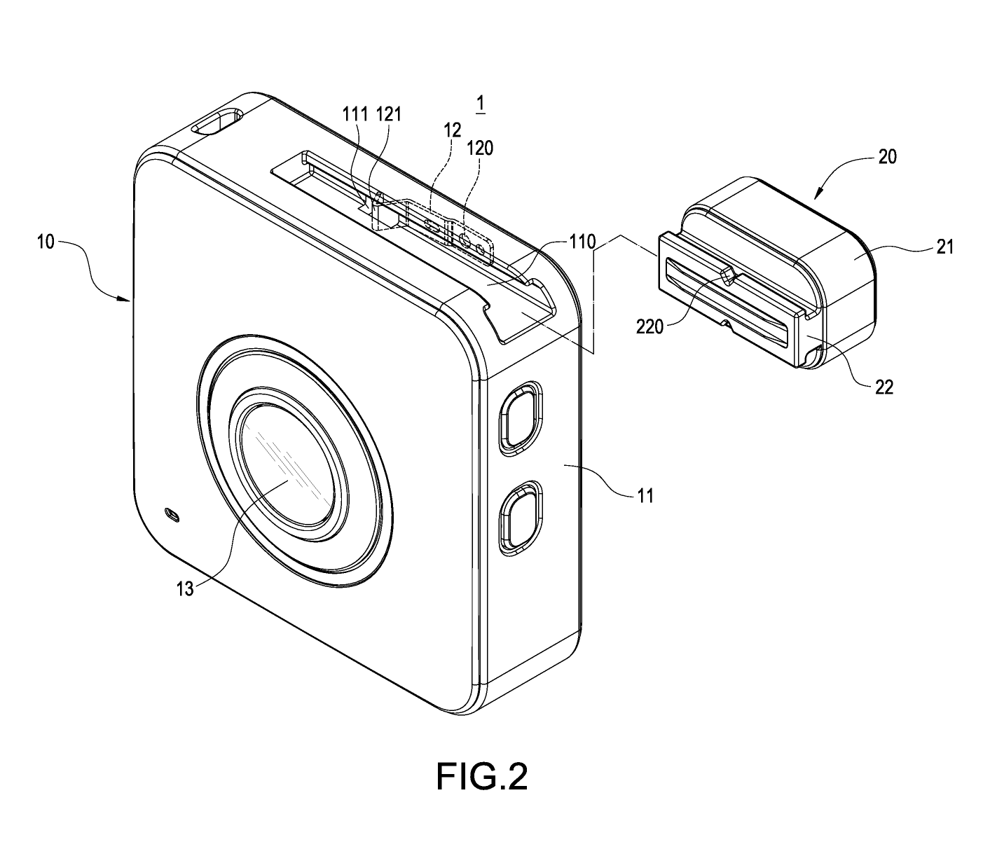

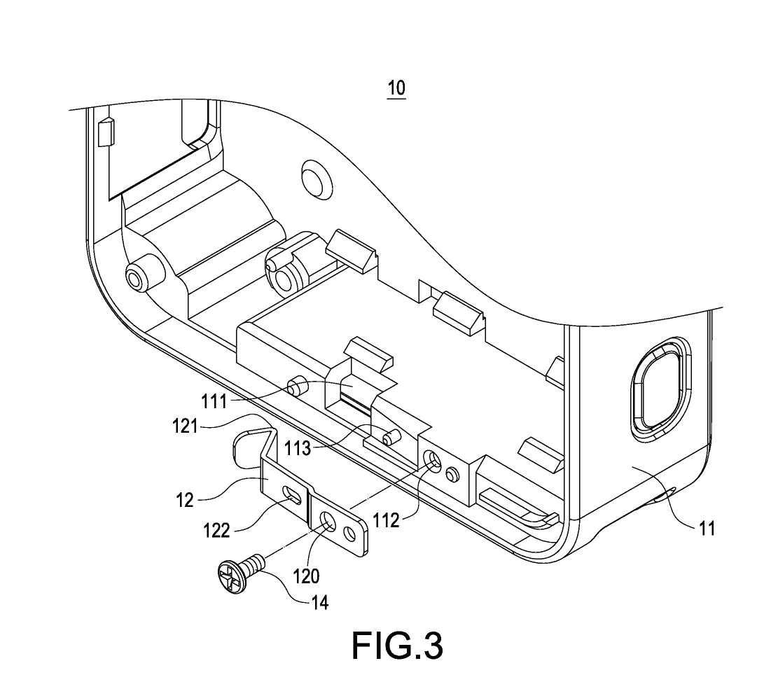

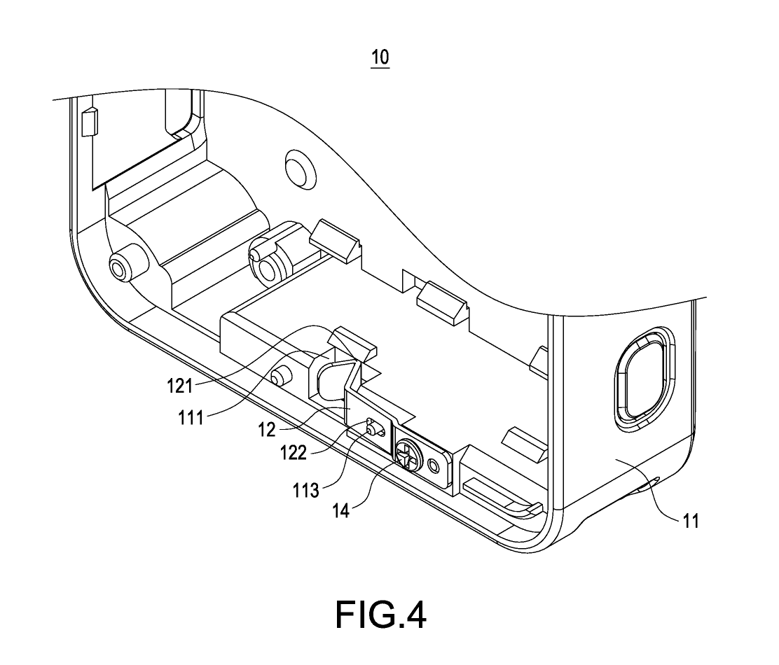

With refer to FIG. 2 to FIG. 4, they depict a schematic view of the sliding seat combining with the electronic imaging device, a partially exploded view of the electronic imaging device, and a partially assembling view of the electronic imaging device of the present invention, respectively. The electronic imaging device 10 includes a housing 11. One side of the housing is provided with a sliding slot 110 and a locking element 12 disposed in the sliding slot 110. In the present invention, the locking element 12 is a resilient piece provided inside the housing 11, and an opening 111 is disposed along a path of the sliding slot 110. The locking element 12 has a hook 121 corresponding to a position of the opening 111. The hook 121 is protruded outward to the sliding slot 110 from the opening 111.

In a preferred embodiment of the present invention, a lens 13 is provided on one side of the electronic imaging device 10. The sliding slot 110 is located on another side of the housing 11 and perpendicular to the lens 13. Preferably, the sliding slot 110 is a T-shaped slot, and the slider 22 is a T-shaped bump. Furthermore, the locking element 12 is a metal sheet. One end of the locking element 12 is provided with at least one lock-hole 120, and the other end is formed with the hook 121.

In the present embodiment, the engaging structure 1 further includes a screw 14, and the housing 11 has a screw hole 112 inside. The screw 14 passes through the lock-hole 120 of the locking element 12 and is screwed in the screw hole 112 of the housing 11. Moreover, the housing 11 has a positioning column 113 near the screw hole 112. The locking element 12 has a positioning slot 122, and the positioning column 113 is located in the positioning slot 122. More detail structures of the sliding slot 110 will be described later.

Preferably, the housing 11 is a cube. One end of the sliding slot 110 is located at the corner of the housing 11, and the sliding slot 110 is extended along one side of the housing 11 to another corner of the housing 11 oppositely. Besides, a predetermined distance is held between the other end of the sliding slot 110 and the opposite corner of the housing 11.

Please refer to FIG. 1 and FIG. 2. The sliding seat 20 includes a base 21 and a slider 22 locating in one side of the base 21. A junction part 211 is disposed in another side of the base 21, and the slider 22 has a notch 220 disposed corresponding to the hook 121. In the present invention, the notch 220 is substantially a triangular recess, and the shape of the notch 220 is corresponding to the shape of the hook 121 of the locking element 12. Besides, the junction part 211 can be implemented as a screw hole. The screw hole can be provided to screw the supporter 2 for supporting the electronic imaging device 10.

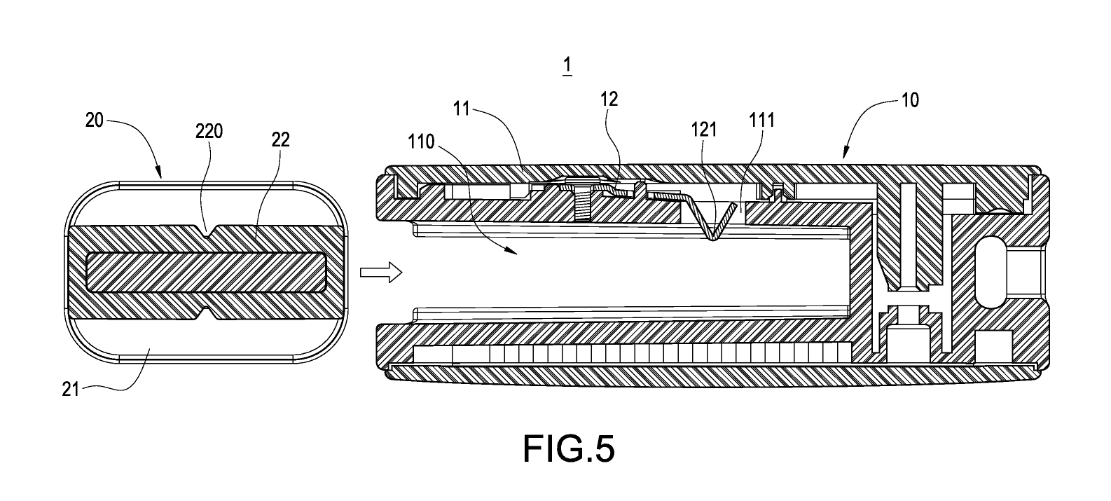

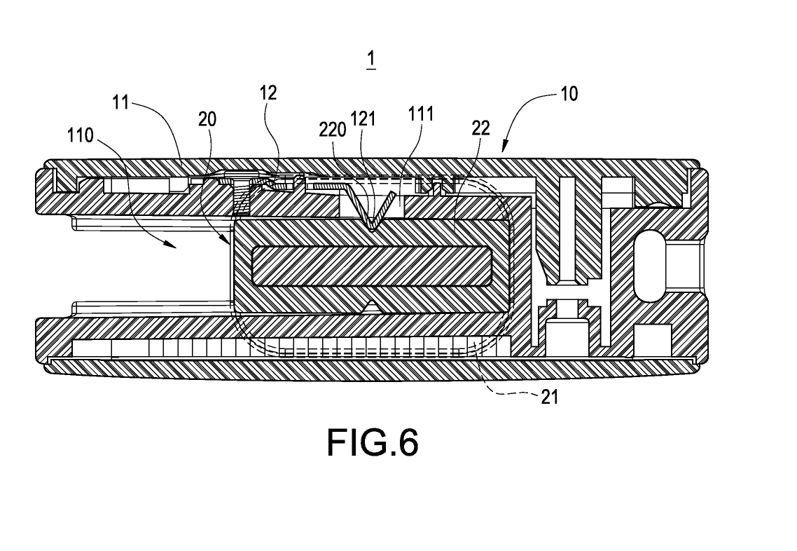

Please refer to the FIG. 5 and FIG. 6, they depict a combining schematic view of the engaging structure and a cross sectional view of the engaging structure of the present invention. As illustrated in FIGs, the sliding seat 20 is slidably arranged in the bottom of the housing 11. After the slider 22 sliding along the path of the sliding slot 110 for a distance, the hook 121 and the locking element 12 will buckle into the notch 220. In other words, the slider 22 slips into the sliding slot 110, and the hook 121 locks the slider 22 in the notch 220.

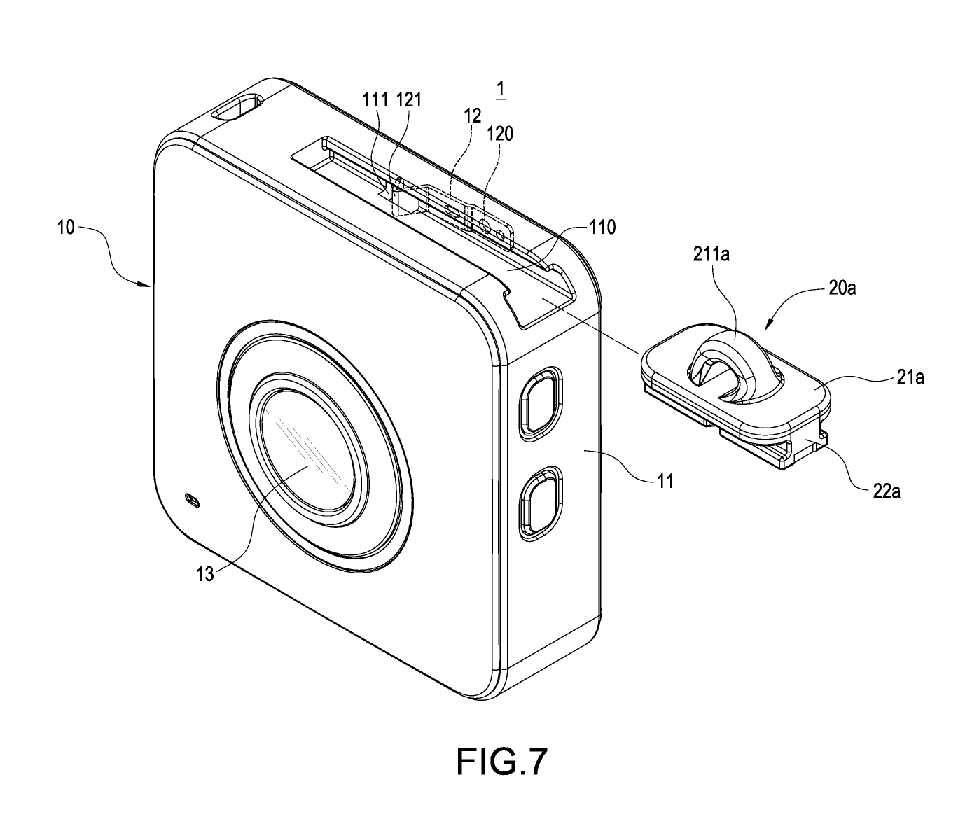

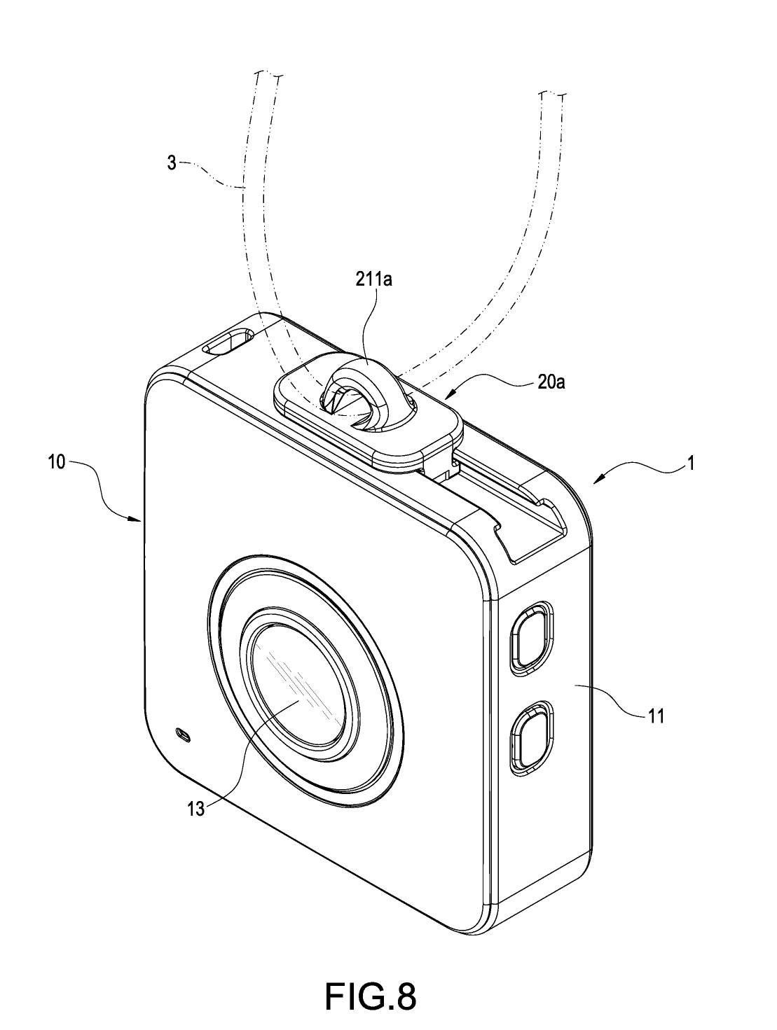

With refers to FIG. 7 and FIG. 8, they depict the sliding seat according to the second embodiment and an application view of the second embodiment of the present invention. The present embodiment is substantially the same as the first embodiment. An engaging structure 1 includes an electronic imaging device 10 and a sliding seat 20a. In this embodiment, the structure of electronic imaging device 10 is the same as the one in the first embodiment. The electronic imaging device 10 includes a housing 11 and a locking element 12 fixed inside the housing 11. One side of the housing 11 is provided with a sliding slot 110, and an opening 111 is located in the path of the sliding slot 110. The sliding seat 20a includes a base 21 a and a slider 22a locating in one side of the base 21a. A junction part 211 is disposed in another side of the base 21a.

This embodiment differs from the first embodiment in that the sliding seat 20a is an annulation. The annulation is used for allowing a rope 3 to pass through, which is for wearing the electronic imaging device 10. Users can wear the electronic imaging device 10 on the chest by using the sliding seat 20a and the rope 3 for carry easily.

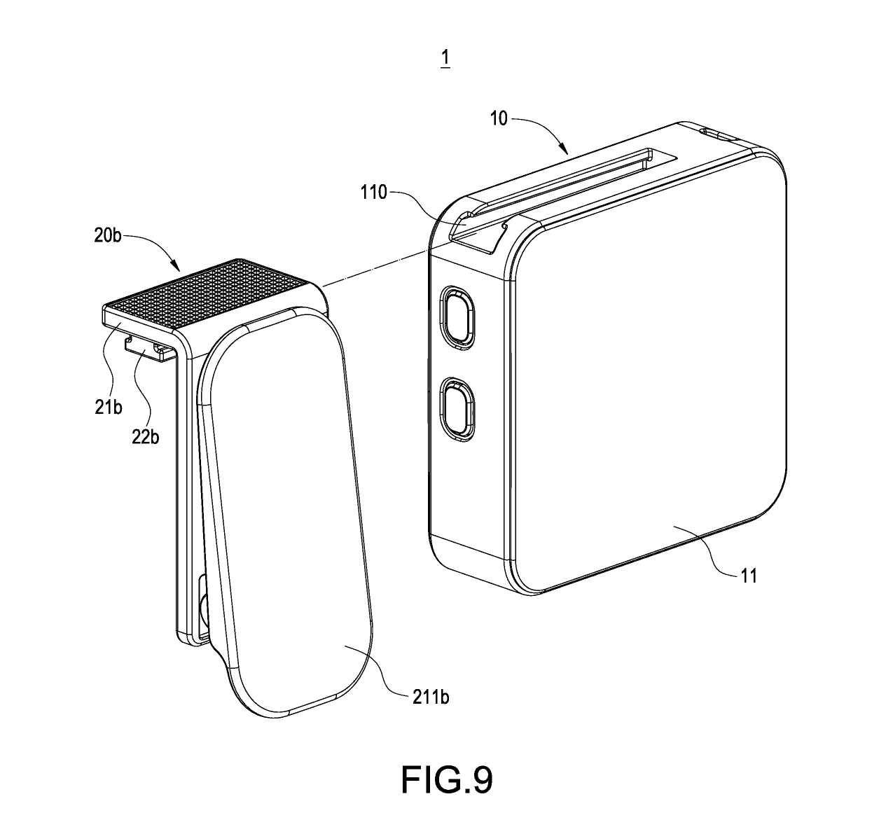

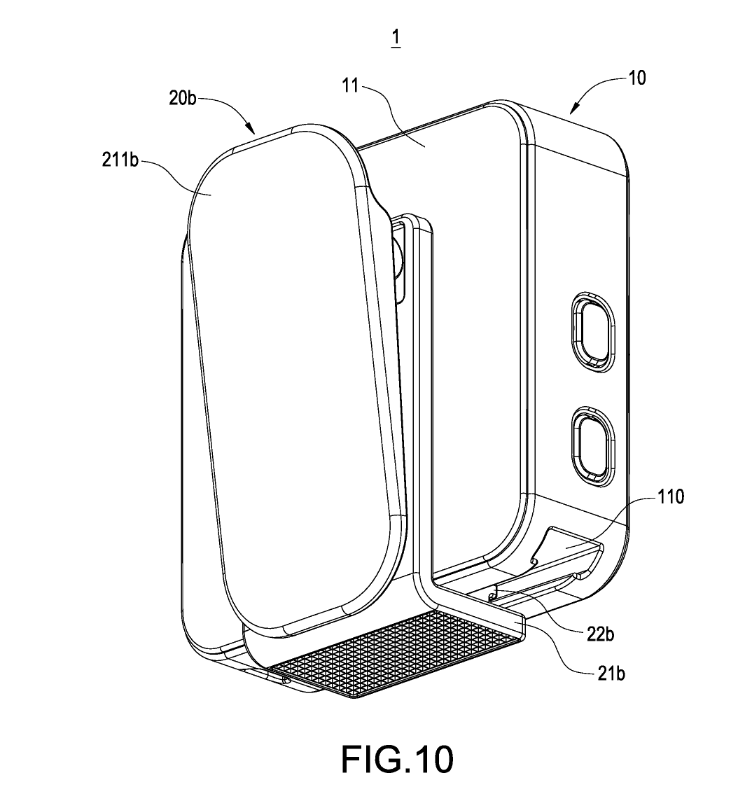

Please refer to the FIG. 9 and FIG. 10, they depict the sliding seat according to the third embodiment and application view of the third embodiment of the present invention. An engaging structure 1 includes an electronic imaging device 10 and a sliding seat 20b. In this embodiment, the structure of the electronic imaging device 10 is the same as the one in the first embodiment. One side of the housing 11 is provided with a sliding slot 110. The sliding seat 20b includes a base 21b and a slider 22b locating in one side of the base 21b. A junction part 211b is disposed in another side of the base 21b.

This embodiment differs from the first embodiment in that the junction part 211b is a resilient clip. With the resilient clip, users can wear the electronic imaging device 10 on a pocket, a belt or some other objects that can be clamped.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. An engaging structure of an electronic imaging device, comprising:
an electronic imaging device including a housing, a sliding slot provided in one side of the housing, and a locking element disposed in the sliding slot; and
a sliding seat including a base and a slider located in one side of the base, a junction part disposed in another side of the base, wherein the slider slides into the sliding slot, and the locking element is used for fixing the slider in the sliding slot that the electronic imaging device will combine with the sliding seat.

2. The engaging structure according to claim 1, wherein the locking element is a resilient piece provided inside the housing, an opening is disposed along a path of the sliding slot, and the resilient piece has a hook corresponding to a position of the opening, the hook is protruded outward to the sliding slot from the opening; and
a notch disposed corresponding to the hook, wherein the slider slides into the sliding slot and the hook locks the slider in the notch.

3. The engaging structure according to claim 1, wherein a lens is provided on one side of the electronic imaging device, the sliding slot is located on another side of the housing and perpendicular to the lens.

4. The engaging structure according to claim 1, wherein the sliding slot is a T-shaped slot, and the slider is a T-shaped bump.

5. The engaging structure according to claim 2, wherein the resilient piece is a metal sheet, one end of the resilient piece is provided with at least one lock-hole and the other end is formed with the hook.

6. The engaging structure according to claim 5, further including a screw, wherein the housing has a screw hole disposed inside, and the screw passes through the lock-hole of the resilient piece and screws in the screw hole of the housing.

7. The engaging structure according to claim 6, wherein the housing has a positioning column near the screw hole, the resilient piece has a positioning slot, and the positioning column is located in the positioning slot.

8. The engaging structure according to claim 1, wherein the housing is a cube, one end of the sliding slot is located at the corner of the housing, and the sliding slot is extended along one side of the housing to another corner of the housing oppositely.

9. The engaging structure according to claim 8, wherein a predetermined distance is held between the other end of the sliding slot and the opposite corner of the housing.

10. The engaging structure according to claim 1, wherein the junction part is provided as a screw hole, in which the screw hole is provided to screw a supporter for supporting the electronic imaging device.

11. The engaging structure according to claim 1, wherein the junction part is an annulation.

12. The engaging structure according to claim 1, wherein the junction part is a resilient clip.
